(19) United States
(12) Patent Application Publication
(10) Pub. No.: US 2018/0217654 A1
(43) Pub. Date: Aug. 2, 2018

(54) POWER-SAVING PROCESSING METHOD, DEVICE, MOBILE TERMINAL AND CLOUD SERVER

(71) Applicant: BEIJING KINGSOFT INTERNET SECURITY SOFTWARE CO., LTD., BEIJING (CN)

(72) Inventors: Yipeng ZOU, BEIJING (CN); Qi YANG, BEIJING (CN); Jian TANG, BEIJING (CN); Guoqiang JIAO, BEIJING (CN); Kangzong ZHANG, BEIJING (CN)

(21) Appl. No.: 15/747,348

(22) PCT Filed: Jul. 29, 2016
(86) PCT No.: PCT/CN2016/092357

§ 371 Date: Jan. 24, 2018

(30) Foreign Application Priority Data
Jul. 31, 2015 (CN) 201510465337.4

(51) Int. Cl. G06F 1/32

(52) U.S. Cl. CPC G06F 1/3228; G06F 1/329

(57) ABSTRACT

The present disclosure provides a power-saving processing method, a power-saving processing device, a mobile terminal and a cloud server. The method may be applied to a client, and includes: collecting information related to an application in an operating system of the client and information related to a client user, to form client characteristic information, in which the information related to the application includes at least one of running information of the application, activity information of the application, and scene information related to the application; uploading the client characteristic information to a cloud server; and receiving a personalized power-saving strategy formed by the cloud server for the client user according to the client characteristic information, and performing power-saving operation on the application according to the personalized power-saving strategy.

### CROSS-REFERENCE TO RELATED APPLICATION

This application is a US national phase application of International Application No. PCT/CN2016/092357, filed Jul. 29, 2016, which is based on and claims priority to and benefits of Chinese Patent Application Serial No. 201510465337.4, filed with the State Intellectual Property Office of P. R. China on Jul. 31, 2015, the entire content of which is incorporated herein by reference.

### FIELD

The present disclosure relates to a computer technology field, and more particularly to a power-saving processing method, a power-saving processing device, a mobile terminal, and a cloud server.

### BACKGROUND

With the continuous progress of science and technology, the development of smart phones is getting more and more quickly. The smart phone does not only have simple functions such as making a phone call and sending a message, but also has functions such as viewing news, shopping, booking a ticket, listening to music, and viewing videos, which are realized by installing various applications (APP for short) connected to the internet. However, the more the APPs installed are, the greater the power consumption of a battery of the smart phone is. Thus, how to intelligently save power has become a bottleneck of the development of smart phones.

At present, the smart phone can realize power-saving through a built-in power-saving mode or by installing a third-party application. However, mostly, a corresponding power-saving strategy is performed according to power situation, which is not flexible enough. For example, in a case of low power, the internet connection is turned off when the screen of mobile phone is not lit, and the internet connection is restored when the screen of mobile phone is lit, which may cause a problem that the mobile phone can not receive messages in time, resulting in poor user experience. In addition, the local power-saving strategy has limitations and poor expandability, and thus it is not possible to develop a power-saving strategy satisfying user's requirements.

### SUMMARY

A first aspect of embodiments of the present disclosure provides a power-saving processing method. The method is applied to a client, and includes: collecting information related to an application in an operating system of the client and information related to a client user, to form client characteristic information, in which the information related to the application includes at least one of running information of the application, activity information of the application, and scene information related to the application; uploading the client characteristic information to a cloud server; and receiving a personalized power-saving strategy formed by the cloud server for the client user according to the client characteristic information, and performing power-saving operation on the application according to the personalized power-saving strategy.

A second aspect of embodiments of the present disclosure provides a power-saving processing method. The method is applied to a cloud server and includes: receiving client characteristic information collected by a client, in which the client characteristic information is formed according to information related to an application in an operating system of the client and information related to a client user, the information related to the application includes at least one of running information of the application, activity information of the application, and scene information related to the application; and generating a personalized power-saving strategy according to the client characteristic information, and returning the personalized power-saving strategy to the client, such that the client performs power-saving operation on the application according to the personalized power-saving strategy.

A third aspect of embodiments of the present disclosure provides a power-saving processing device, including: a collecting module, configured to collect information related to an application in an operating system of the client and information related to a client user, to form client characteristic information, in which the information related to the application comprises at least one of running information of the application, activity information of the application, and scene information related to the application; an uploading module, configured to upload the client characteristic information to a cloud server; and a processing module, configured to receive a personalized power-saving strategy formed by the cloud server for the client user according to the client characteristic information, and to perform power-saving operation on the application according to the personalized power-saving strategy.

A fourth aspect of embodiments of the present disclosure provides a power-saving processing device, including: a receiving module, configured to receive client characteristic information collected by a client, in which the client characteristic information is formed according to information related to an application in an operating system of the client and information related to a client user, the information related to the application includes at least one of running information of the application, activity information of the application, and scene information related to the application; a determining module, configured to generate a personalized power-saving strategy according to the client characteristic information; and a returning module, configured to return the personalized power-saving strategy to the client, such that the client performs power-saving operation on the application according to the personalized power-saving strategy.

A fifth aspect of embodiments of the present disclosure provides a mobile terminal. The mobile terminal includes a housing, a processor, a memory, a circuit board, and a power circuit, in which the circuit board is arranged inside a space enclosed by the housing; the processor and the memory are disposed on the circuit board; the power circuit is configured to provide power for respective circuits or components of the mobile terminal; the memory is configured to store executable program codes; and the processor is configured to run a program corresponding to the executable program codes by reading the executable program codes stored in the memory, so as to perform a power-saving processing method according to the first aspect of embodiments of the present disclosure.

A sixth aspect of embodiments of the present disclosure provides a cloud server. The cloud server includes a processor; and a memory, configured to store instructions executable by the processor; in which the processor is configured to read the executable instructions stored in the memory, so as to perform a power-saving processing method according to the second aspect of embodiments of the present disclosure.

A seventh aspect of embodiments of the present disclosure provides a computer readable storage medium, having stored therein instructions that, when executed by a processor of a mobile terminal, cause the mobile terminal to perform a power-saving processing method according to the first aspect of embodiments of the present disclosure.

An eighth aspect of embodiments of the present disclosure provides a computer readable storage medium, having stored therein instructions that, when executed by a processor of a cloud server, cause the cloud server to perform a power-saving processing method according to the second aspect of embodiments of the present disclosure.

A ninth aspect of embodiments of the present disclosure provides a computer program, configured to perform a power-saving processing method according to the first aspect of embodiments of the present disclosure when running on a processor of a mobile terminal.

A tenth aspect of embodiments of the present disclosure provides a computer program, configured to perform a power-saving processing method according to the second aspect of embodiments of the present disclosure when running on a processor of a cloud server.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a flow chart of a power-saving processing method according to an embodiment of the present disclosure;

FIG. 2 is a flow chart of a power-saving processing method according to another embodiment of the present disclosure;

FIG. 3 is a block diagram illustrating a power-saving processing device according to an embodiment of the present disclosure;

FIG. 4 is a block diagram illustrating a power-saving processing device according to an embodiment of the present disclosure;

FIG. 5 is a block diagram illustrating a power-saving processing device according to another embodiment of the present disclosure;

FIG. 6 is a block diagram illustrating a power-saving processing device according to another embodiment of the present disclosure;

FIG. 7 is a block diagram illustrating a mobile terminal according to an embodiment of the present disclosure;

FIG. 8 is a block diagram illustrating a cloud server according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

A power-saving processing method, a power-saving processing device, a mobile terminal, and a cloud server according to embodiments of the present disclosure will be described below with reference to drawings.

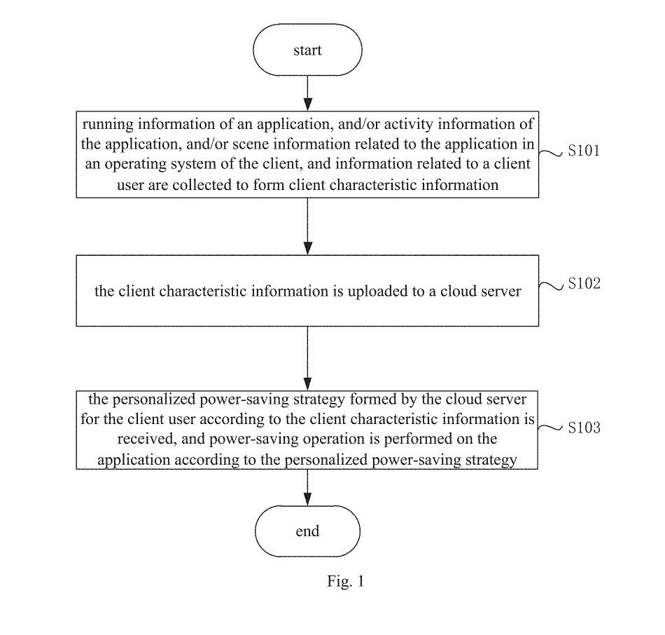

FIG. 1 is a flow chart of a power-saving processing method according to an embodiment of the present disclosure. This embodiment is applied to a client. As illustrated in FIG. 1, the method includes followings.

At block S101, running information of an application, and/or activity information of the application, and/or scene information related to the application in an operating system of the client, and information related to a client user are collected to form client characteristic information.

The running information of the application may include a name of the application, type information of the application, runtime of the application, network flow consumption information of the application, memory usage information of the application in the client, CPU usage information of the application in the client, and the like. For example, WeChat belongs to a social application, occupies 2% of the memory, and a CPU utilization rate of WeChat is 4%.

The activity information of the application may include designated folder information corresponding to the application, designated progress information corresponding to the application, account login status of the application, system service information corresponding to the application, priority information of a progress corresponding to the application, and the like. For example, WeChat is installed in a tencent/MicroMsg folder, is currently in a logging in status, and needs to call which system service information, etc.

The scene information related to the application may include an outdoor scene, an indoor scene, a sleeping scene, an aviation scene, an in-vehicle scene, and the like. For example, the current client is in the outdoor scene.

The information related to the client user may include a user name of the client user, authority information of the client user, operation information of the client user on the application in the client, and the like.

After the above-mentioned running information, the activity information, the scene information, and the information related to the client user are obtained, the above-mentioned information may be organized, thus forming the client characteristic information.

At block S102, the client characteristic information is uploaded to a cloud server.

After the client characteristic information is formed, the client characteristic information may be uploaded to the cloud server. The cloud server may analyze the client characteristic information, determine a personalized power-saving strategy for the client user, and return the personalized power-saving strategy.

At block S103, the personalized power-saving strategy formed by the cloud server for the client user according to the client characteristic information is received, and power-saving operation is performed on the application according to the personalized power-saving strategy.

In detail, the client may receive the personalized power-saving strategy formed by the cloud server for the client user according to the client characteristic information, and perform various power-saving operations on the application according to the personalized power-saving strategy, such as performing a progress killing operation, or performing a force stop operation on the application, or performing a prohibiting automatic start operation on the application, or performing a restart operation on the application, or prohibiting the application from performing network connection, or performing a uninstall operation on the application.

For example, the client user uses WeChat with a high frequency, the client user uses Cheetah safe browser to view news online, and the client user is accustomed to close a GPS positioning function when using for example Douban movie. Then, based on the above information, a personalized power-saving strategy may be customized for the client user, such that Wechat can still receive messages in real time and can keep in a logging in state when the client user is not using WeChat, Cheetah safe browser is reserved while other browsers with a low usage frequency are closed, and the GPS positioning function in Douban movie is closed.

It should be understood that, above-mentioned examples are only simple examples, and it may be more complex in actual situation. As time goes on, further client characteristic information that has never appeared before may appear, and the personalized power-saving strategy may be updated accordingly, which is not listed one by one herein.

In addition, after the personalized power-saving strategy formed by the cloud server for the client user according to the client characteristic information is received, the client may store the personalized power-saving strategy to local. When detecting that the client is disconnected from the cloud server, the client may obtain corresponding personalized power-saving strategy from the local, and perform the power-saving operation on the application according to the personalized power-saving strategy. For example, assume that the client cannot communicate with the cloud server after the client receives the personalized power-saving strategy returned by the cloud server, then the client may obtain the personalized power-saving strategy previously stored to local, and perform the power-saving operation on the application.

With the power-saving processing method according to embodiments of the present disclosure, by collecting the client characteristic information of the application in the operating system of the client, uploading the client characteristic information, receiving the personalized power-saving strategy formed by the cloud server for the client user according to the client characteristic information, and performing the power-saving operation on the application according to the personalized power-saving strategy, it is more intelligent and more personalized, thus improving user experience.

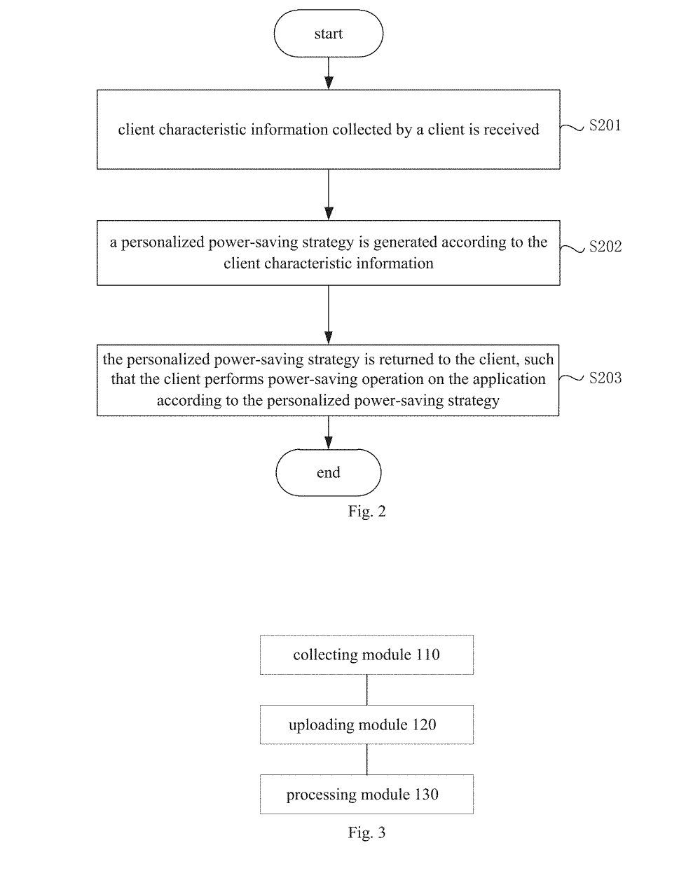

FIG. 2 is a flow chart of a power-saving processing method according to another embodiment of the present disclosure. This embodiment is applied to a cloud server. As illustrated in FIG. 2, the method includes followings.

At block S201, client characteristic information collected by a client is received.

The client characteristic information is formed according to running information of an application, and/or activity information of the application, and/or scene information related to the application in an operating system of the client, and information related to a client user.

The running information of the application may include a name of the application, type information of the application, runtime of the application, network flow consumption information of the application, memory usage information of the application in the client, CPU usage information of the application in the client, and the like. For example, WeChat belongs to a social application, occupies 2% of the memory, and a CPU utilization rate of WeChat is 4%.

The activity information of the application may include designated folder information corresponding to the application, designated progress information corresponding to the application, account login status of the application, system service information corresponding to the application, priority information of a progress corresponding to the application, and the like. For example, WeChat is installed in a tencent/MicroMsg folder, is currently in a logging in status, and needs to call which system service information.

The scene information related to the application may include an outdoor scene, an indoor scene, a sleeping scene, an aviation scene, an in-vehicle scene, and the like. For example, the current client is in the outdoor scene.

The information related to the client user may include a user name of the client user, authority information of the client user, operation information of the client user on the application in the client, and the like.

At block S202, a personalized power-saving strategy is generated according to the client characteristic information.

In detail, a user type of the client user may be determined according to the scene information related to the application and the information related to the client user, and then the client characteristic information and the user type are analyzed, and the personalized power-saving strategy is set for the client user.

For example, if current scene information is the indoor scene, and if it is detected that chat records in WeChat are constantly updated in a long period, it may be determined that the user type of the client user is an indoor-chat type.

For another example, if current scene information is the outdoor scene, and if it is detected that a map APP is in an open state from eight clock to ten clock every evening, and GPS positioning information of is constantly changing, and at the same time, data information (such as heart rate change currently monitored, exercise distance, consumed calorie, and the like) of an exercise APP is changing, it may be determined that the user type of the client user is an outdoor-exercise type.

Certainly, above are just examples, and the client user is not limited to only one user type, which may be one type in one period, and may be another type in another period.

At block S203, the personalized power-saving strategy is returned to the client, such that the client performs power-saving operation on the application according to the personalized power-saving strategy.

The personalized power-saving strategy may be stored into a database, after the personalized power-saving strategy is set for the client user.

The database is stored in the cloud server, and is configured to store the personalized power-saving strategy.

With the power-saving processing method according to embodiments of the present disclosure, by receiving the client characteristic information collected by the client, generating the personalized power-saving strategy according to the client characteristic information, and returning the personalized power-saving strategy to the client, the client can perform the power-saving operation on the application according to the personalized power-saving strategy, which is more intelligent and more personalized, thus improving user experience.

To realize above embodiments, the present disclosure further provides a power-saving processing device.

FIG. 3 is a block diagram illustrating a power-saving processing device according to an embodiment of the present disclosure. As illustrated in FIG. 3, the device includes a collecting module 110, an uploading module 120, and a processing module 130.

The collecting module 110 is configured to collect running information of an application, and/or activity information of the application, and/or scene information related to the application in an operating system of the client, and information related to a client user, to form client characteristic information.

The running information of the application may include a name of the application, type information of the application, runtime of the application, network flow consumption information of the application, memory usage information of the application in the client, CPU usage information of the application in the client, and the like. For example, WeChat belongs to a social application, occupies 2% of the memory, and a CPU utilization rate of WeChat is 4%.

The activity information of the application may include designated folder information corresponding to the application, designated progress information corresponding to the application, account login status of the application, system service information corresponding to the application, priority information of a progress corresponding to the application, and the like. For example, WeChat is installed into a tencent/MicroMsg folder, is currently in a logging in status, and needs to call which system service information.

The scene information related to the application may include an outdoor scene, an indoor scene, a sleeping scene, an aviation scene, an in-vehicle scene, and the like. For example, the current client is in the outdoor scene.

The information related to the client user may include a user name of the client user, authority information of the client user, operation information of the client user on the application in the client, and the like.

After the above-mentioned running information, the activity information, the scene information, and the information related to the client user are obtained, the above-mentioned information may be organized, thus forming the client characteristic information.

The uploading module 120 is configured to upload the client characteristic information to a cloud server.

After the client characteristic information is formed, the uploading module 120 may upload the client characteristic information to the cloud server. The cloud server may analyze the client characteristic information, determine a personalized power-saving strategy for the client user, and return the personalized power-saving strategy.

The processing module 130 is configured to receive a personalized power-saving strategy formed by the cloud server for the client user according to the client characteristic information, and to perform power-saving operation on the application according to the personalized power-saving strategy.

In detail, the processing module 130 may receive the personalized power-saving strategy formed by the cloud server for the client user according to the client characteristic information, and perform various power-saving operations on the application according to the personalized power-saving strategy, such as performing a progress killing operation, or performing a force stop operation on the application, or performing a prohibiting automatic start operation on the application, or performing a restart operation on the application, or prohibiting the application from performing network connection, or performing a uninstall operation on the application.

For example, the client user uses WeChat with a high frequency, the client user uses Cheetah safe browser to view news online, and the client user is accustomed to close a GPs positioning function when using for example Douban movie. Then, based on the above information, a personalized power-saving strategy may be customized for the client user, such that Wechat can still receive messages in real time and can keep in a logging in state when the client user is not using WeChat, Cheetah safe browser is reserved while other browsers with a low usage frequency are closed, and the GPS positioning function in Douban movie is closed.

It should be understood that, above-mentioned examples are only simple examples, and it may be more complex in actual situation. As time goes on, further client characteristic information that has never appeared before may appear, and the personalized power-saving strategy may be updated accordingly, which is not listed one by one herein.

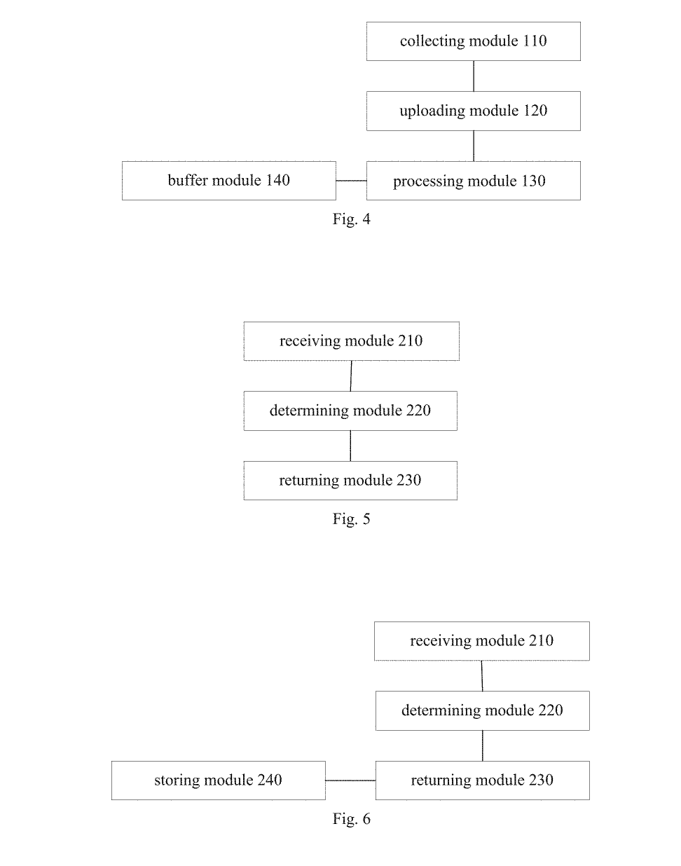

In addition, as illustrated in FIG. 4, the power-saving processing device according to embodiments of the present disclosure may further include a buffer module 140.

The buffer module 140 is configured to store the personalized power-saving strategy to local after the personalized power-saving strategy formed by the cloud server for the client user according to the client characteristic information is received. When detecting that the client is disconnected from the cloud server, the processing module 130 may obtain corresponding personalized power-saving strategy from the local, and perform the power-saving operation on the application according to the personalized power-saving strategy. For example, assume that the client cannot communicate with the cloud server after the client receives the personalized power-saving strategy returned by the cloud server, then the client may obtain the personalized power-saving strategy previously stored to local, and then perform the power-saving operation on the application.

With the power-saving processing device according to embodiments of the present disclosure, by collecting the client characteristic information of the application in the operating system of the client, uploading the client characteristic information, receiving the personalized power-saving strategy formed by the cloud server for the client user according to the client characteristic information, and performing the power-saving operation on the application according to the personalized power-saving strategy, it is more intelligent and more personalized, thus improving user experience.

FIG. 5 is a block diagram illustrating a power-saving processing device according to another embodiment of the present disclosure. As illustrated in FIG. 5, the device includes a receiving module 210, a determining module 220, and a returning module 230.

The receiving module 210 is configured to receive client characteristic information collected by a client.

The client characteristic information is formed according to running information of an application, and/or activity information of the application, and/or scene information related to the application in an operating system of the client, and information related to a client user.

The running information of the application may include a name of the application, type information of the application, runtime of the application, network flow consumption information of the application, memory usage information of the application in the client, CPU usage information of the application in the client, and the like. For example, WeChat belongs to a social application, occupies 2% of the memory, and a CPU utilization rate of WeChat is 4%.

The activity information of the application may include designated folder information corresponding to the application, designated progress information corresponding to the application, account login status of the application, system service information corresponding to the application, priority information of a progress corresponding to the application, and the like. For example, WeChat is installed in a tencent/MicroMsg folder, is currently in a logging in status, and needs to call which system service information.

The scene information related to the application may include an outdoor scene, an indoor scene, a sleeping scene, an aviation scene, an in-vehicle scene, and the like. For example, the current client is in the outdoor scene.

The information related to the client user may include a user name of the client user, authority information of the client user, operation information of the client user on the application in the client, and the like.

The determining module 220 is configured to generate a personalized power-saving strategy according to the client characteristic information.

In detail, the determining module 220 may determine a user type of the client user according to the scene information related to the application and the information related to the client user, and then analyze the client characteristic information and the user type, and set the personalized power-saving strategy for the client user.

For example, if current scene information is the indoor scene, and if it is detected that chat records in WeChat are constantly updated in a long period, it may be determined that the user type of the client user is an indoor-chat type.

For another example, if current scene information is the outdoor scene, and if it is detected that a map APP is in an open state from eight clock to ten clock every evening, and GPS positioning information is constantly changing, and at the same time, data information (such as heart rate change currently monitored, exercise distance, consumed calorie, and the like) of an exercise APP is changing, it may be determined that the user type of the client user is an outdoor-exercise type.

Certainly, above are just examples, and the client user is not limited to only one user type, which may be one type in one period, and may be another type in another period.

The returning module 230 is configured to return the personalized power-saving strategy to the client, such that the client performs power-saving operation on the application according to the personalized power-saving strategy.

In addition, as illustrated in FIG. 6, the power-saving processing device according to embodiments of the present disclosure may further include a storing module 240.

The storing module 240 is configured to store the personalized power-saving strategy into a database after the personalized power-saving strategy is set for the client user.

The database is stored in the cloud server, and is configured to store the personalized power-saving strategy.

With the power-saving processing device according to embodiments of the present disclosure, by receiving the client characteristic information collected by the client, generating the personalized power-saving strategy according to the client characteristic information, and returning the personalized power-saving strategy to the client, the client can perform the power-saving operation on the application according to the personalized power-saving strategy, which is more intelligent and more personalized, thus improving user experience.

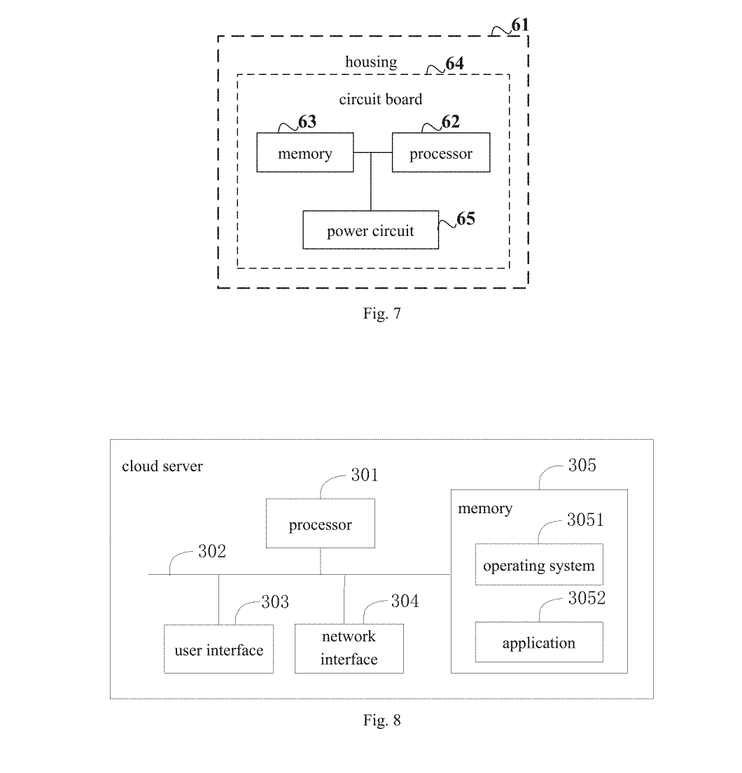

To realize above embodiments, the present disclosure further provides a mobile terminal. FIG. 7 is a block diagram illustrating a mobile terminal according to an embodiment of the present disclosure. As illustrated in FIG. 7, the mobile terminal includes a housing 61, a processor 62, a memory 63, a circuit board 64, and a power circuit 65. The circuit board 64 is arranged inside a space enclosed by the housing 61. The processor 62 and the memory 63 are disposed on the circuit board 64. The power circuit 65 is configured to provide power for respective circuits or components of the mobile terminal. The memory 63 is configured to store executable program codes. The processor 62 is configured to run a program corresponding to the executable program codes by reading the executable program codes stored in the memory 63, so as to perform following steps.

In step S101′, running information of an application, and/or activity information of the application, and/or scene information related to the application in an operating system of the client, and information related to a client user are collected to form client characteristic information.

The running information of the application may include a name of the application, type information of the application, runtime of the application, network flow consumption information of the application, memory usage information of the application in the client, CPU usage information of the application in the client, and the like. For example, WeChat belongs to a social application, occupies 2% of the memory, and a CPU utilization rate of WeChat is 4%.

The activity information of the application may include designated folder information corresponding to the application, designated progress information corresponding to the application, account login status of the application, system service information corresponding to the application, priority information of a progress corresponding to the application, and the like. For example, WeChat is installed in a tencent/MicroMsg folder, is currently in a logging in status, and needs to call which system service information.

The scene information related to the application may include an outdoor scene, an indoor scene, a sleeping scene, an aviation scene, an in-vehicle scene, and the like. For example, the current client is in the outdoor scene.

The information related to the client user may include a user name of the client user, authority information of the client user, operation information of the client user on the application in the client, and the like.

After the above-mentioned running information, the activity information, the scene information, and the information related to the client user are obtained, the above-mentioned information may be organized, thus forming the client characteristic information.

In step S102′, the client characteristic information is uploaded to a cloud server.

After the client characteristic information is formed, the client characteristic information may be uploaded to the cloud server. The cloud server may analyze the client characteristic information, determine a personalized power-saving strategy for the client user, and return the personalized power-saving strategy.

In step S103′, the personalized power-saving strategy formed by the cloud server for the client user according to the client characteristic information is received, and power-saving operation is performed on the application according to the personalized power-saving strategy.

In detail, the client may receive the personalized power-saving strategy formed by the cloud server for the client user according to the client characteristic information, and perform various power-saving operations on the application according to the personalized power-saving strategy, such as performing a progress killing operation, or performing a force stop operation on the application, or performing a prohibiting automatic start operation on the application, or performing a restart operation on the application, or prohibiting the application from performing network connection, or performing a uninstall operation on the application.

For example, the client user uses WeChat with a high frequency, the client user uses Cheetah safe browser to view news online, and the client user is accustomed to close a GPS positioning function when using for example Douban movie. Then, based on the above information, a personalized power-saving strategy may be customized for the client user, such that Wechat can still receive messages in real time and can keep in a logging in state when the client user is not using WeChat, Cheetah safe browser is reserved while other browsers with a low usage frequency are closed, and the GPS positioning function in Douban movie is closed.

It should be understood that, above-mentioned examples are only simple examples, and it may be more complex in actual situation. As time goes on, further client characteristic information that has never appeared before may appear, and the personalized power-saving strategy may be updated accordingly, which is not listed one by one herein.

The mobile terminal in embodiments of the present disclosure may include a mobile phone, a smart phone, a notebook computer, a digital broadcast receiver, a personal digital assistant (PDA), a portable android device (PAD), a portable media player (PMA), a navigation device, a desktop, and other mobile terminals.

With the mobile terminal according to embodiments of the present disclosure, by collecting the client characteristic information of the application in the operating system of the client, uploading the client characteristic information, receiving the personalized power-saving strategy for the client user formed by the cloud server according to the client characteristic information, and performing the power-saving operation on the application according to the personalized power-saving strategy, it is more intelligent and more personalized, thus improving user experience.

To realize above embodiments, the present disclosure further provides a cloud server. The cloud server includes the power-saving processing device according to another embodiment of the present disclosure illustrated in FIG. 5 and FIG. 6.

FIG. 8 is a block diagram illustrating a cloud server according to an embodiment of the present disclosure. As illustrated in FIG. 8, the cloud server is configured to perform a power-saving processing method according to embodiments of the present discloser. The cloud server may include: at least one processor 301 such as a CPU, at least one network interface 304 or other user interfaces 303, a memory 305, and at least one communication bus 302. The communication bus 302 is configured to realize connection and communication between these components. The user interface 303 may alternatively include a USB interface and other standard interfaces and wired interfaces. The network interface 304 may alternatively include a Wi-Fi interface and other wireless interfaces. The memory 305 may include a high speed RAM memory, or may include a non-volatile memory, such as at least one disk memory. The memory 305 may alternatively include at least one storage device located away from the foregoing processor 301. As illustrated in FIG. 8, the memory 305, as one kind of computer storage medium, may include an operating system 3051 and an application 3052.

In some embodiments, the memory 305 stores executable modules or data structure, or their subsets, or their extension sets.

The operating system 3051 includes various system programs, and is configured to implement various basis services and to process hardware-based tasks.

The application 3052 includes various applications including a setting program of data block parameter of target network data, a dividing program of a target data block, a comparing program of the target data block and data block in a database, and a deleting program of the target data block, and the like, and is configured to implement various application services.

In detail, the processor 301 is configured to call programs stored in the memory 305 to perform following operations:

receiving client characteristic information collected by a client, in which the client characteristic information is formed according to information related to an application in an operating system of the client and information related to a client user. The information related to the application includes at least one of running information of the application, activity information of the application, and scene information related to the application;

generating a personalized power-saving strategy according to the client characteristic information, and returning the personalized power-saving strategy to the client, such that the client performs power-saving operation on the application according to the personalized power-saving strategy.

Particular execution process of the above steps by the processor 301 and steps further performed through running program by the processor 301 can refer to description of above method embodiments, which will not described in detail.

With the cloud server according to embodiments of the present disclosure, by receiving the client characteristic information collected by the client, generating the personalized power-saving strategy according to the client characteristic information, and returning the personalized power-saving strategy to the client, the client can perform the power-saving operation on the application according to the personalized power-saving strategy, which is more intelligent and more personalized, thus improving user experience.

Embodiments of the present disclosure also provide a computer readable storage medium, having stored therein instructions that, when executed by a processor of a mobile terminal, cause the mobile terminal to perform a power-saving processing method according to an embodiment of the present disclosure illustrated in FIG. 1.

Embodiments of the present disclosure also provide a computer readable storage medium, having stored therein instructions that, when executed by a processor of a cloud server, cause the cloud server to perform a power-saving processing method according to an embodiment of the present disclosure illustrated in FIG. 2.

Embodiments of the present disclosure also provide a computer program, which is configured to perform a power-saving processing method according to an embodiment of the present disclosure illustrated in FIG. 1 when running on a processor of a mobile terminal.

Embodiments of the present disclosure also provide a computer program, which is configured to perform a power-saving processing method according to an embodiment of the present disclosure illustrated in FIG. 2 when running on a processor of a cloud server.

It should be noted that relationship terms such as first and second are only used herein to distinguish an entity or operation from another entity or operation, and it is not necessarily required or implied that there are any actual relationship or order of this kind between those entities and operations. Moreover, terms such as “comprise”, “comprising” and any other variants are intended to cover non-exclusive contains, so that the processes, methods, articles or devices including a series of elements not only include those elements but also include other elements that are not listed definitely, or also include the elements inherent in the processes, methods, articles or devices. In the case of no more restrictions, the elements defined by the statement ‘comprise one . . . ’ do not exclude that other same elements also exist in the processes, methods, articles or devices including the elements.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

In the present invention, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, in a case without contradictions, different embodiments or examples or features of different embodiments or examples may be combined by those skilled in the art.

Although explanatory embodiments have been shown and described, it would be appreciated by those skilled in the art that the above embodiments are explanatory and cannot be construed to limit the present disclosure, and changes, alternatives, and modifications can be made in the embodiments without departing from scope of the present disclosure.

1. A power-saving processing method, applied to a client, comprising:
collecting information related to an application in an operating system of the client and information related to a client user, to form client characteristic information, wherein the information related to the application comprises at least one of running information of the application, activity information of the application, and scene information related to the application;
uploading the client characteristic information to a cloud server; and
receiving a personalized power-saving strategy for the client user formed by the cloud server according to the client characteristic information, and performing power-saving operation on the application according to the personalized power-saving strategy.

2. The method according to claim 1, wherein the running information of the application comprises at least one of:
a name of the application;
type information of the application;
runtime of the application;
network flow consumption information of the application;
memory usage information of the application in the client; and
CPU usage information of the application in the client.

3. The method according to claim 1, wherein the activity information of the application comprises at least one of:
designated folder information corresponding to the application;
designated progress information corresponding to the application;
account login status of the application;
system service information corresponding to the application; and
priority information of a progress corresponding to the application.

4. The method according to claim 1, wherein the scene information related to the application comprises at least one of:
an outdoor scene, an indoor scene, a sleeping scene, an aviation scene, and an in-vehicle scene.

5. The method according to claim 1, wherein the information related to a client user comprises at least one of:
a user name of the client user;
authority information of the client user; and
operation information of the client user on the application in the client.

6. The method according to claim 1, wherein performing power-saving operation on the application according to the personalized power-saving strategy comprises:
performing a progress killing operation on the application according to the personalized power-saving strategy; or
performing a force stop operation on the application according to the personalized power-saving strategy; or
prohibiting automatic start of the application according to the personalized power-saving strategy; or
performing a restart operation on the application according to the personalized power-saving strategy; or
prohibiting the application from performing network connection according to the personalized power-saving strategy; or
performing a uninstall operation on the application according to the personalized power-saving strategy.

7. The method according to claim 1, further comprising:
after receiving the personalized power-saving strategy for the client user formed by the cloud server according to the client characteristic information, storing the personalized power-saving strategy to local.

8. A power-saving processing method, applied to a cloud server, comprising:
receiving client characteristic information collected by a client, wherein the client characteristic information is formed according to information related to an application in an operating system of the client and information related to a client user, and the information related to the application comprises at least one of running information of the application, activity information of the application, and scene information related to the application; and
generating a personalized power-saving strategy according to the client characteristic information, and returning the personalized power-saving strategy to the client, such that the client performs power-saving operation on the application according to the personalized power-saving strategy.

9. The method according to claim 8, wherein the running information of the application comprises at least one of:
a name of the application;
type information of the application;
runtime of the application;
network flow consumption information of the application;
memory usage information of the application in the client; and
CPU usage information of the application in the client.

10. The method according to claim 8, wherein the activity information of the application comprises at least one of:
designated folder information corresponding to the application;
designated progress information corresponding to the application;
account login status of the application;
system service information corresponding to the application; and
priority information of a progress corresponding to the application.

11. The method according to claim 8, wherein the scene information related to the application comprises at least one of:
an outdoor scene, an indoor scene, a sleeping scene, an aviation scene, and an in-vehicle scene.

12. The method according to claim 8, wherein generating a personalized power-saving strategy according to the client characteristic information comprises:
determining a user type of the client user according to the scene information related to the application and the information related to the client user; and
analyzing the client characteristic information and the user type, and setting the personalized power-saving strategy for the client user.

13. The method according to claim 8, further comprising:
after setting the personalized power-saving strategy for the client user, storing the personalized power-saving strategy into a database.

14. A power-saving processing device, comprising:
a processor; and
a memory, configured to store instructions executable by the processor,
wherein the processor is configured to:
collect information related to an application in an operating system of the client and information related to a client user, to form client characteristic information, wherein the information related to the application comprises at least one of running information of the application, activity information of the application, and scene information related to the application;
upload the client characteristic information to a cloud server; and
receive a personalized power-saving strategy for the client user formed by the cloud server according to the client characteristic information, and to perform power-saving operation on the application according to the personalized power-saving strategy.

15. The device according to claim 14, wherein the running information of the application comprises at least one of:
a name of the application;
type information of the application;
runtime of the application;
network flow consumption information of the application;
memory usage information of the application in the client; and
CPU usage information of the application in the client.

16. The device according to claim 14, wherein the activity information of the application comprises at least one of:
designated folder information corresponding to the application;
designated progress information corresponding to the application;
account login status of the application;
system service information corresponding to the application; and
priority information of a progress corresponding to the application.

17. The device according to claim 14, wherein the scene information related to the application comprises at least one of:
an outdoor scene, an indoor scene, a sleeping scene, an aviation scene, and an in-vehicle scene.

18. The device according to claim 14, wherein the information related to a client user comprises at least one of:
a user name of the client user;
authority information of the client user; and
operation information of the client user on the application in the client.

19. The device according to claim 14, wherein the processor is configured to:
perform a progress killing operation on the application according to the personalized power-saving strategy; or
perform a force stop operation on the application according to the personalized power-saving strategy; or
prohibit automatic start of the application according to the personalized power-saving strategy; or
perform a restart operation on the application according to the personalized power-saving strategy; or
prohibit the application from performing network connection according to the personalized power-saving strategy; or
perform a uninstall operation on the application according to the personalized power-saving strategy.

20. The device according to claim 14, wherein the processor is further configured to:
store the personalized power-saving strategy to local.

21-32. (canceled)
